(19) United States
(12) Patent Application Publication
(10) Pub. No.: US 2009/0173756 A1
(43) Pub. Date: Jul. 9, 2009

(54) DISPENSING DEVICE

(76) Inventor: Peter Sage-Passant, Milton Keynes (GB)

Correspondence Address: KNOBBE MARTENS OLSON & BEAR LLP, 2040 MAIN STREET, FOURTEENTH FLOOR, IRVINE, CA, 92614, US

(21) Appl. No.: 12/162,170

(22) PCT Filed: Dec. 13, 2006
(86) PCT No.: PCT/GB2006/004658

§ 371 Date: Dec. 22, 2008

(30) Foreign Application Priority Data
Jan. 30, 2006 (GB) 0601757.8

(51) Int. Cl. B67D 3/00; B65D 35/56; B67D 5/38; B67D 5/06

(52) U.S. Cl. 222/504; 222/105; 222/156; 222/183

(57) ABSTRACT

A dispensing system (2) for a grease degrading enzyme fluid includes a container (20) for fluid to be dispensed, a fluid flow tube (30) for allowing fluid to flow from the container to an outlet (36), and an electrically operated valve (32) for controlling the flow of fluid through the tube. The system also includes a control circuit (42) for actuating the valve (32) to dispense fluid at predetermined intervals and a battery (44) for supplying power to the valve and the control circuit.

The present invention relates to a dispensing device and in particular, but not exclusively, a dispensing device for automatically dispensing grease degrading enzyme fluid into commercial kitchen drains.

Sink units in commercial kitchens are usually provided with grease traps to prevent the drain becoming blocked with grease deposits. However, grease traps can present a hygiene hazard in food preparation areas, they are bulky and they require high maintenance, being difficult to clean and empty.

Recent UK legislation requires all commercial kitchens to have an effective means of grease management. One way of achieving this is by regular use of a grease degrading enzyme fluid. Regular use of such a fluid effectively degrades and disperses grease deposits in the drain, thereby avoiding the need for a grease trap.

Various systems exist for dispensing grease degrading fluids. However, these are generally inconvenient or not well suited to a kitchen environment. The grease degrading fluid is generally supplied in drums, which are bulky and take up valuable floor space. The existing systems also generally require a mains electricity supply and sometimes also a water supply.

It is an object of the present invention to provide a dispensing system that mitigates at least some of the aforesaid disadvantages.

According to the present invention there is provided a dispensing system including a container for a fluid to be dispensed, a fluid flow tube for allowing fluid to flow from the container to an outlet, an electrically operated valve for controlling the flow of fluid through the tube, a control circuit for actuating the valve to dispense fluid at predetermined intervals and a battery for supplying power to the valve and the control circuit.

The system provides for effective grease management by automatically dispensing a dose of grease degrading enzyme fluid into the drain at regular intervals. This prevents any build up of grease deposits and avoids the need for laborious and potentially unhygienic cleaning of grease traps. The unit is self contained and can be mounted on a wall above the sink unit so that it does not occupy valuable floor space. It does not require either a mains electricity supply or a water supply and installation is therefore quick and simple.

Advantageously, the system includes a housing that encloses the container, the valve, the control circuit and the battery. The housing encloses the components to protect them from damage and allows the unit to be cleaned easily.

Advantageously, the container includes a flexible bag inside a substantially rigid outer box. This arrangement allows the container to be replaced very easily and without mess when the fluid has been used up. The containers are also very easy to store. The container preferably includes a connection fitting for connection to the fluid flow tube. Advantageously, the connection fitting includes a non-drip valve, to prevent leakage during connection to the fluid flow tube.

Advantageously, the container is supported by a resilient spring element, so that in use the vertical position of the container varies according to the weight of fluid in the container. This ensures that the static head of the fluid is substantially constant for consistent delivery. Preferably, the system includes an indicator for indicating the quantity of fluid in the container according to its vertical position, so that it can be replaced when empty.

The fluid preferably includes a grease degrading enzyme.

Advantageously, the dispensing system is constructed and arranged to be mounted on a wall, for example above a sink unit.

An embodiment of the invention will now be described by way of example with reference to the accompanying drawings, in which:

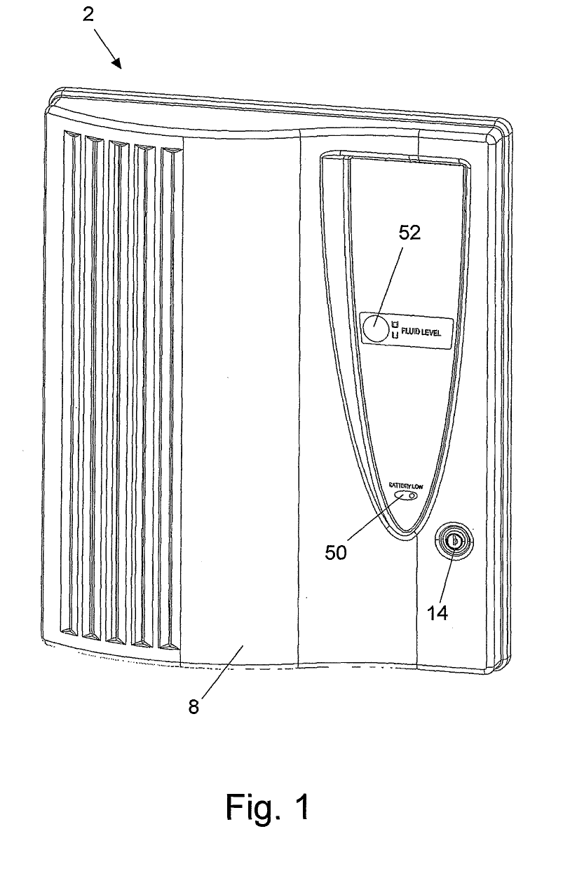

FIG. 1 is a perspective view showing the front of the dispensing system;

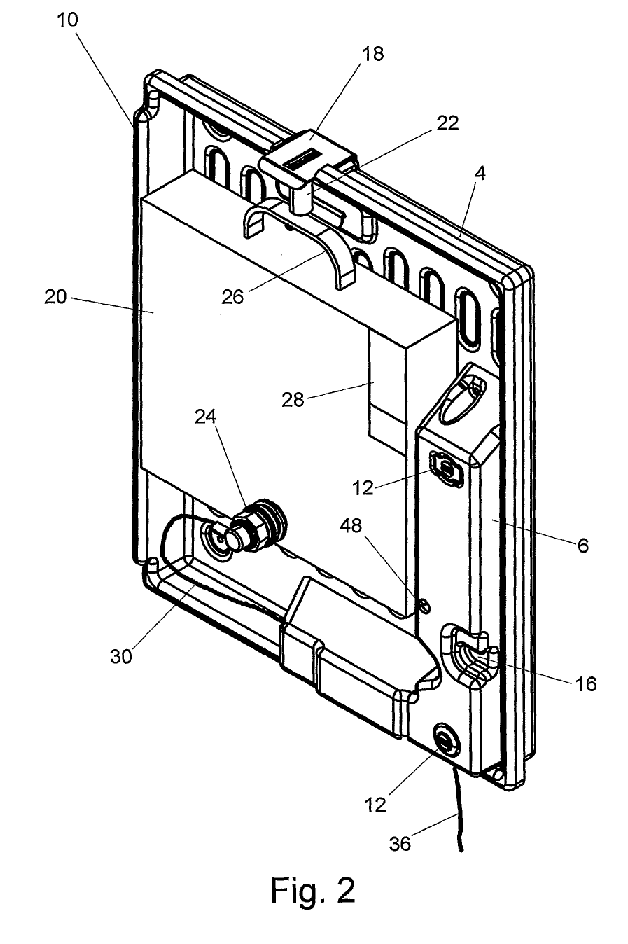

FIG. 2 is a perspective view showing the front of the system with a front cover removed; and

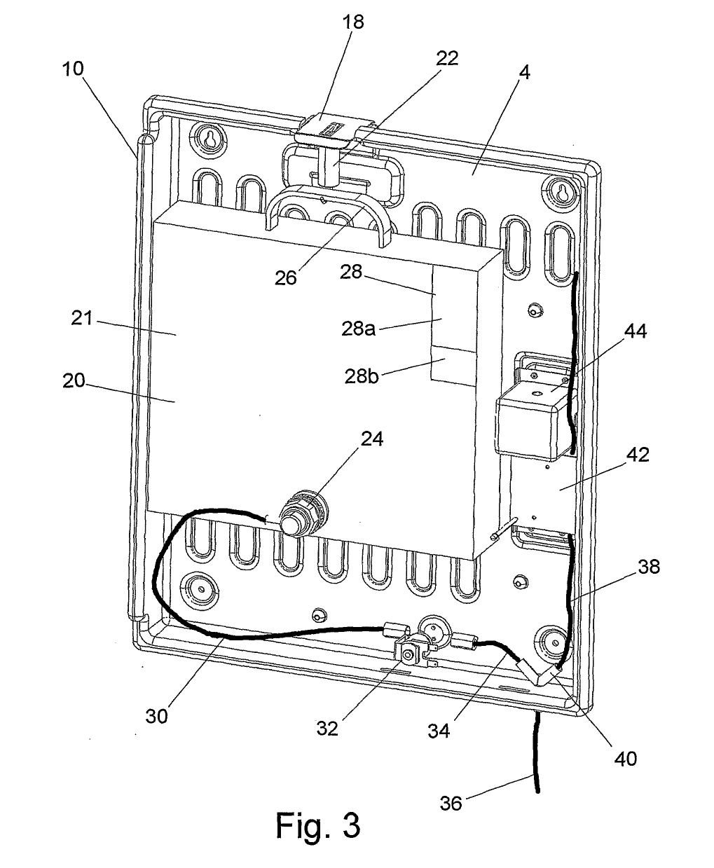

FIG. 3 is a perspective view showing the front of the dispensing system with the front cover and an internal cover removed.

As shown in the drawings, the dispensing system 2 includes a housing comprising a wall plate 4 that is designed to be mounted on a wall above a sink unit (not shown), an inner cover 6 that is removably attached to the wall plate 4 (for example with screws), and an outer cover 8 that is attached to the wall plate 4 by means of a hinge 10. Magnetic latches 12 are provided on the inner cover 6 and are positioned to engage the front cover 8 when it is closed. A key lock 14 is provided on the front cover 8 and engages a locking recess 16 on the inner cover 6 to lock the front cover closed.

The wall plate 4 has a bracket 18 at its upper edge, which supports a container 20 for a grease degrading enzyme fluid via a tension spring 22. The container 20 consists of an outer box 21 of a suitable rigid material (for example cardboard or a plastics material) and a flexible inner bag (not shown) of a suitable plastics film material. The bag is sealed to a non-drip connection fitting 24, that extends through the rigid outer box 21 at the lower edge of the container 20. At its upper edge, the container 20 includes a handle 26 that is supported by the spring 22. The container also includes a label 28 on its front face, which indicates in use the amount of fluid remaining in the container. This is described in more detail below.

The connection fitting 24 is connected via a fluid supply tube 30 to the inlet side of an electrically operated latching dosing valve 32. The outlet side of the valve 32 is connected via a second fluid supply tube 34 to an outlet tube 36, through which fluid is supplied to the drain of the sink unit (not shown). An air vent tube 38 is also connected to the outlet tube 36 via a Y connector 40. The air vent tube 38 prevents the formation of an airlock in the supply tube 36, ensuring reliable delivery of the enzyme fluid to the drain.

Operation of the valve 32 is controlled by a control circuit 42, which is powered by a battery 44. The valve 32 draws power for only 25 milliseconds as it latches open or closed and draws no power when at rest, in order to prolong the battery life. Battery life is projected at up to two years. A low battery indicator light 46 is provided to indicate when the battery 44 needs replacing. The electronic components including the battery 44, the circuit board 42 and the valve 32 are covered and protected from damage by the inner cover 6. The inner cover can be removed to allow replacement of the battery 44. The inner cover 6 and the front cover 8 both include windows 48,50 respectively, through which the indicator lamp 46 can be seen.

The front cover 8 also includes a second window 52 through which part of the fluid level indicator label 28 can be seen. The label 28 is divided into an upper part 28a and a lower part 28b, which are marked for example with different colours to indicate how much fluid remains in the container 20. The part of the label that can be seen through the window 52 depends on the weight of the fluid in the container 20 and the resulting extension of the support spring 22. When the container 20 is full, the spring 22 is stretched by the weight of the fluid and only the upper part 28a of the label can been seen. When only a small-quantity of fluid remains in the container, or when the container is empty, the spring 22 contracts, thereby lifting the container 20. Only the lower part 28b of the label can then be seen through the window 52. The lower part of the label may be coloured red or another suitable colour, to indicate that the container 20 needs replacing.

The support spring 22 serves a second function of ensuring that the static head of the fluid remains substantially constant as the container empties. Therefore, as fluid is supplied from the container 20 and the container becomes lighter, it is lifted higher by the support spring 22, so that the static head of the fluid remains substantially constant. This ensures consistent delivery of fluid to the drain.

In use, fluid is dispensed from the container 20 into the drain of the sink through the outlet tube 36 at regular intervals as controlled by the control circuit 42. Typically, a dose of fluid will be supplied to the drain once every night, so that it has several hours in which to degrade grease in the drain before the kitchen resumes operation in the morning. The quantity of fluid supplied to the drain per dose and the frequency of dosing can both be adjusted by the programming of the control circuit 42.

When the fluid container 20 is empty, it can be replaced with a new full container by opening the front cover 8, disconnecting the supply tube 30 from the connection fitting 24 and releasing the handle 26 from the support spring 22. The new container can then be hooked onto the support spring 22 and the supply line 30 can be plugged into the connection fitting 24. The fitting 24 includes a non-drip valve to prevent fluid leaking from the container before the supply line 30 is connected. Inserting the supply line 30 into the connection fitting 24 opens the valve allowing the fluid to flow.

1. A dispensing system including a container for a fluid to be dispensed, a fluid flow tube for allowing fluid to flow from the container to an outlet, an electrically operated valve for controlling the flow of fluid through the tube, a control circuit for actuating the valve to dispense fluid at predetermined intervals, a battery for supplying power to the valve and the control circuit, and a housing that encloses the container, the valve, the control circuit and the battery, in which the container is supported within the housing by a resilient spring element so that in use the vertical position of the container within the housing varies according to the weight of fluid in the container, and wherein the container includes an indicator for indicating the quantity of fluid in the container according to its vertical position within the housing.

2. A dispensing system according to claim 1, in which the housing includes a window for viewing the indicator.

3. dispensing system according to claim 1, in which the container includes a flexible bag inside a substantially rigid outer box.

4. A dispensing system according to claim 1, in which the container includes a connection fitting for connection to the fluid flow tube.

5. A dispensing system according to claim 4, in which the connection fitting includes a non-drip valve.

6. (canceled)

7. (canceled)

8. A dispensing system according to claim 1, in which the fluid includes a grease degrading enzyme.

9. A dispensing system according to claim 1, wherein the dispensing system is constructed and arranged to be mounted on a wall.

10. A dispensing system according to claim 1, wherein the valve for controlling the flow of fluid is an electrically operated latching valve.
